(19) United States
(12) Patent Application Publication
(10) Pub. No.: US 2012/0215641 A1
(43) Pub. Date: Aug. 23, 2012

(54) SYSTEM AND METHOD FOR DETERMINING DESTINATION CHARACTERISTICS OF VEHICLE OPERATORS

(75) Inventor: Eric Ohki, Rancho Palos Verdes, OH (US)

(73) Assignee: HONDA MOTOR CO., LTD., Tokyo (JP)

(21) Appl. No.: 13/029,725

(22) Filed: Feb. 17, 2011

(51) Int. Cl. G08G 1/00; G06Q 30/00

(52) U.S. Cl. 705/14.62; 340/901

(57) ABSTRACT

An intelligent telematics system that estimates an operator's characteristics or predict the operator's probable actions based on information collected at an on-board telematics unit and/or received from online services. The on-board telematics unit collects information for extracting a driving pattern of the operator of a vehicle. Such driving pattern information is processed in conjunction with information related to the operator available from the online services to intelligently predict or estimate the operator's preferences, characteristics or probable actions. The on-board telematics unit provides information or services customized for the operator according to the predicted or estimated preferences, characteristics and probable actions.

### FIELD OF THE INVENTION

This disclosure is related to presenting information to operators at an on-board telematics unit installed on a vehicle, more specifically to predicting actions or estimating characteristics of the operators and recommending destinations or displaying advertisements at the on-board telematics units.

### BACKGROUND OF THE INVENTION

On-board telematics units are widely used in vehicles to provide various useful services to their operators. Typical on-board telematics include GPS (global positioning system) navigation unit that provides turn-by-turn routing information to a desired destination. Some high-end telematics units provide additional services including, among others, remote location or vehicle state tracking, remote controlling of components in vehicles, emergency response services, stolen vehicle tracking, and navigation information downloads. Such on-board telematics units have made driving safe and convenient for many drivers.

Some on-board telematics units are connected to various components of the vehicles to monitor and detect the states of the components. For example, an on-board telematics unit may sense engine temperature, the speed of the vehicle, the operating states of electronic components in the vehicle, and whether seat belts are buckled up. If the on-board telematics units detect abnormal states in the vehicle, an alert may be issued to the operator or sent to a remote facility for remedial actions.

Although on-board telematics units provide various useful services to the operators, these units still remain largely disconnected from various online services available, for example, via the Internet. Although some on-board telematics units are capable of retrieving data (e.g., traffic data) via wireless communication, most on-board telematics units have limited or no capability to connect with Internet or online services. Hence, the on-board telematics units are generally incapable of leveraging the vast amount of information available on online services.

### SUMMARY OF THE INVENTION

Embodiments provide an intelligent telematics system for predicting actions or estimating an operator's characteristics by analyzing information available from sources such as a telematics unit in a vehicle or online services. The information collected from the telematics unit and other sources are processed to extract the operator's pattern of driving. The extracted driving pattern allows the intelligent telematics system to generate and present information useful and relevant to the operator of the vehicle.

In one embodiment, the telematics unit senses the state of vehicles during a driving session by receiving signals from sensors installed in the vehicle. The sensors also allow the telematics unit to determine the destination and other information associate with a driving session without any manual input from the operator. Hence, more information about destinations and driving patterns may be made available for processing.

In one embodiment, the intelligent telematics system analyzes information about the operator from online services. The online services may include social networking services that maintain connections between multiple users. The intelligent telematics system may use information provided by the operator to retrieve information about the users connected to the operator in the online services, and extract characteristics common to the connected users. The operator is assumed to share the common characteristics, and based on such assumption, the intelligent telematics system generates the information for presentation to the operator of the vehicle.

In one embodiment, the information presented to the operator includes recommended destinations, recommended activities or advertisements targeted to the operator. The information is presented to the operator of the vehicle via an on-board telematics unit to assist the operator to search destinations or activities of interest to the operator.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of this disclosure can be readily understood by considering the following detailed description in conjunction with the accompanying drawings.

FIG. 1 is a block diagram illustrating the architecture of an intelligent telematics system, according to one embodiment of the present invention.

FIG. 2 is a block diagram illustrating a block diagram of an on-board telematics unit of the intelligent telematics system, according to one embodiment of the present invention.

FIG. 3 is a diagram illustrating components of a vehicle associated with the on-board telematics unit, according to one embodiment of the present invention.

FIG. 4 is a block diagram illustrating a control center of the intelligent telematics system, according to one embodiment of the present invention.

FIG. 5 is a flowchart illustrating a method of generating information customized for an operator, according to one embodiment of the present invention.

FIG. 6 is a flowchart illustrating for collecting session information, according to one embodiment of the present invention.

FIG. 7 is a flowchart illustrating a process of analyzing the collected information, according to one embodiment of the present invention.

### DETAILED DESCRIPTION OF THE INVENTION

Embodiments of the present invention are now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below.

In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

Embodiments provide a system that intelligently predicts an operator's actions or estimates the operator's characteristics based on information received from an on-board telematics unit and online services. The on-board telematics unit collects information for extracting a driving pattern of the operator of a vehicle. Such driving pattern information is processed in conjunction with information related to the operator available from the online services to intelligently predict actions or estimate the operator's characteristics. The on-board telematics unit provides information or services customized for the operator according to the predicted actions or estimated characteristics of the operator.

A driving pattern herein refers to any statistically significant relationships between variables in previous driving sessions. The variables may include, the time of day or week, the presence of passenger, the speed of the vehicle, weather conditions, traffic congestion status, the starting points of a driving session, and destinations. The driving pattern may indicate, for example, (i) that the operator is likely to head to a certain destination in the morning of weekdays or (ii) that the operator is likely to head to a certain destination from a certain location.

An operator herein refers to a person driving a vehicle or a passenger in the vehicle having access to the on-board telematics unit.

Previous destination information herein refers to information related to previous driving sessions. The previous destination information may included, for example, previous destinations, times associated with each of the previous deriving sessions, mileage traveled, and vehicle states at or during each of the previous driving session.

Current session information herein refers to information related to a current driving session. The current session information may include, for example, the destination as entered by the operator, the current location of the vehicle, current state of the vehicle, and current time.

An online service herein refers to remote functionalities provided to users over a network. The online service includes, among others, an e-mail service, a text messaging service, a social networking service, a weather forecast service, a media sharing service (e.g., TIVO, YouTube and Pandora Radio), an information search service (e.g., Google, MSN, Yahoo, Yelp and OpenTable), an instant messenger service, an online search service, and an online map/traffic information service (e.g., Mapquest, Google and Inrix). An online service is often accessed by multiple users, and may require log-in or authentication to access the service.

Access information herein refers to information for accessing and retrieving information associated with an operator of the vehicle from an online service. The access information, for example, may include a user ID, a password, an email address or other personal information for authenticating the operator at the online service.

### Architecture of Intelligent Telematics System

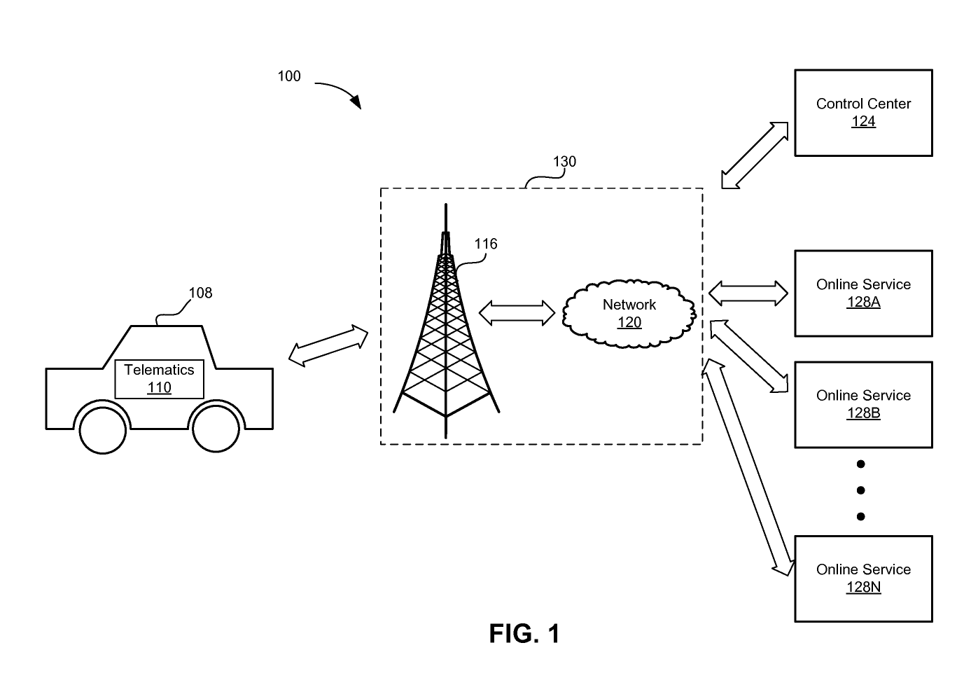

FIG. 1 is a block diagram illustrating the architecture of intelligent telematics system 100, according to one embodiment of the invention. The intelligent telematics system 100 includes, among other components, a vehicle 108, communication infrastructure 130, a control center 124 and multiple online services 128A through 128N (hereinafter collectively referred to as the “online services 128”). The intelligent telematics system 100 processes information about previous destinations and information about the operator of the vehicle to predict actions or estimate the operator's characteristics. The intelligent telematics system 100 then generates information customized to the operator based on the operator's characteristics or probable actions. The customized information is presented to the operator of the vehicle 108 to facilitate planning of itinerary or activities.

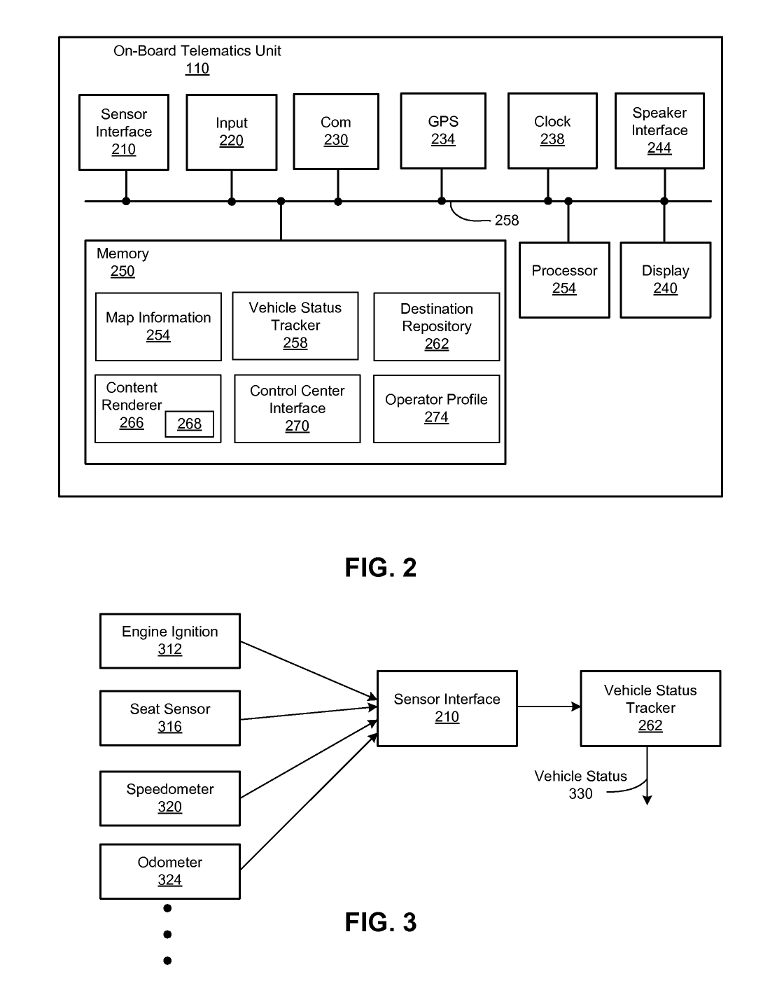

The vehicle 108 is associated with one or more operators who operate the vehicle 108. The vehicle 108 includes an on-board telematics unit 110 that interacts with the operator. The on-board telematics unit 110 may perform various functions including, but not limited to, navigation, vehicle status monitoring, remote controlling of vehicle components, emergency response services, stolen vehicle tracking, and geo-fencing. An example of on-board telematics unit 110 is described below in detail with reference to FIG. 2. Although a single vehicle is illustrated in FIG. 1, a large number of vehicles may take advantage of the intelligent telematics system 100.

The communication infrastructure 130 provides one or more communication channels between the on-board telematics unit 110, the control center 124 and the online services 128. The communication infrastructure 130 may include a cellular network (including cellular tower 116), a satellite communications network and other long range communication systems currently available or to be developed. The communication infrastructure 130 may include or communicate with network 120. The network 120 may include multiple networked devices.

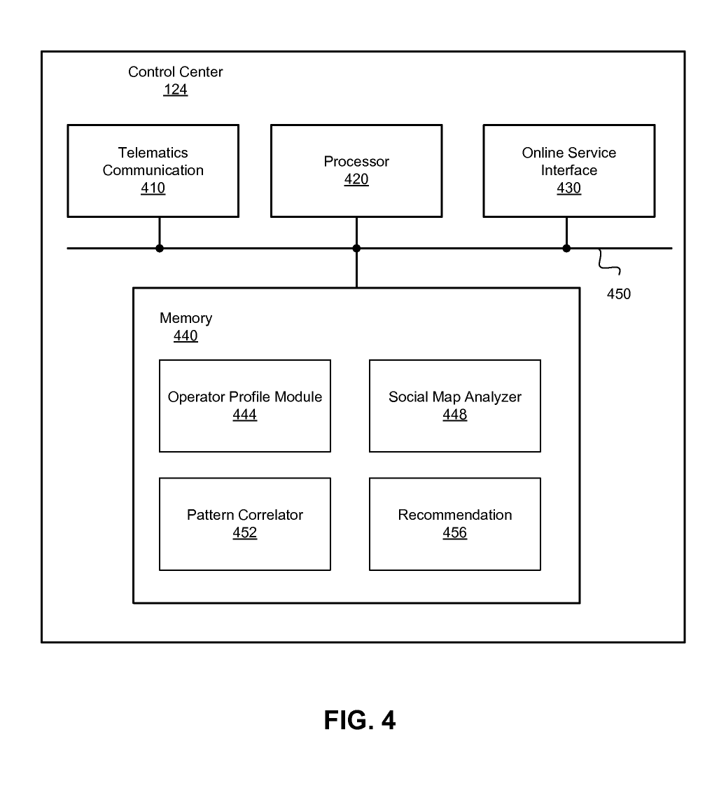

The control center 124 performs various remote telematics operations associated with the on-board telematics unit 110. The control center 124 collects previous destination information as well as information associated with the operator to predict the operator's actions or estimate operator's characteristics, as described below in detail with reference to FIG. 4. The control center 124 may include one or more servers to perform various data mining and automated processes. Although illustrated as a single component in FIG. 1, the control center 124 may be embodied as distributed architecture where facilities or equipments are dispersed throughout different geographic locations.

The online services 128 may include one or more servers, web application data interfaces (API), and other software components to provide functionalities and services to users and the control center 124 over the network 120. In one embodiment, the control center 124 receives information associated with the operator from the online services 128 to better estimate the operator's characteristics or actions. The information provided by the online services 128 may include, among other information, profiles of the operator and identity/profiles of users connected or related to the operator in the online services 128. For example, the information provided by the online services 128 may include a social map representing relationships or connections between various users in an online social networking service.

Although the online services 128 are described as a component separate from the control center 124, the online service 128 may be part of the control center 124. Alternatively, the control center 124 may communicate with one or more online services 128 over a dedicated communication channel instead of the network 120 shared by various networked devices.

Architecture of on-Board Telematics Unit

FIG. 2 is a block diagram illustrating the on-board telematics unit 110, according to one embodiment of the present invention. The on-board telematics unit 110 may include, among other components, sensor interface 210, input module 220, communication module 230, GPS (global positioning system) module 234, clock 238, display 240, memory 250, processor 254, speaker interface 244 and bus 258 connecting these components. The on-board telematics unit 110 may also include additional components such as a voice recognition system or a car entertainment system (not illustrated).

The sensor interface 210 is software, hardware, firmware or a combination thereof for interfacing with physical sensors in the vehicle 108. The sensor interface 210 receives raw sensor signals or pre-processed sensor signals from the physical sensors. As described below in detail with reference to FIG. 3, the on-board telematics unit 110 can track and monitor the states of the vehicle 108 based on the sensor signals received via the sensor interface 210.

The input module 220 is software, hardware, firmware or a combination thereof for receiving input from the operator or passenger of the vehicle 108. The input module 220 may include, for example, a touchscreen, a keypad, a keyboard, a pointing device and switches that receive user input from the operator. The input device 220 may also include a microphone, a voice recognition system, and a camera for performing image, gesture or facial recognition.

The communication module 230 is software, hardware, firmware or a combination thereof for communicating with the control center 124 over the communications infrastructure 130. The communication module 230 may, for example, be employ technology such as cellular telephony, LTE (Long Term Evolution), Wi-Fi, WiMAX (Worldwide Interoperability for Microwave Access), LMDS (Local Multipoint Distribution Service), UMB (Ultra Mobile Broadband), and GMR (Geo-Mobile Radio Interface). The communication module 230 may include multiple sub-modules for establishing communication over two or more distinct communication channels to the control center 124.

The GPS module 234 is hardware, software, firmware or a combination thereof for determining the location of the vehicle 108. The GPS module 234 may include, among other components, a GPS receiver for detecting radio signals from satellites and a signal processor for processing the received radio signals. In one embodiment, the GPS module 234 is supplanted or replaced with other localization systems such as a mobile phone tracking system or an inertial navigation system.

The clock 238 produces reference time information for the on-board telematics unit 110. The reference time information may be included in previous session information and/or current session information. The clock 238 may be part of the on-board telematics unit 110. Alternatively, the clock 238 may be a unit separate from the on-board telematics unit 110.

The processor 254 is a hardware component that reads and executes computer instructions stored in the memory 250. The processor 254 also controls other components of the on-board telematics unit 110 via the bus 258. Although a single processor is illustrated in FIG. 2, two or more processors may be included in the on-board telematics unit 110.

The display 240 is a hardware component that presents visual information to the operator. The display 240 may be embodied using various display technology including, among others, LCD (liquid crystal display), LED (light emitting diode), OLED (organic light emitting diode), ELDs (Electroluminescence displays) and SEDs (Surface-conduction electron-emitter displays). In one embodiment, the display 240 is integrated with the input module 220 in the form of a touchscreen. In another embodiment, the display is part of a heads up display (HUD) unit.

The speaker interface 244 is hardware, software, firmware or a combination thereof for interfacing with a speaker (not shown) in the vehicle. The speaker interface may include, for example, a digital signal processor and an amplifier to generate sound at the speaker.

Software Modules of on-Board Telematics Unit

The on-board telematics unit 110 includes software components for performing or supporting telematics operations. The memory 250 stores, among other software components, map information 254, vehicle status tracker 258, destination repository 262, content renderer 266, control center interface 270 and operator profile 274. One or more of these modules may be combined into a single module. Alternatively, the modules may be split into multiple sub-modules to perform more defined functions. Some or all of the software components in the memory 250 may be embodied as a distinct combination of hardware, software and firmware. Further, some of the functionalities provided by the software components in the memory 250 may be ported to the control center 124 to relieve computational load at the on-board telematics unit 110.

The map information 254 stores information about points of interest (POI), geographical features, and roads or street information. In one embodiment, the map information 254 is accessed by a navigation program (not shown) in the on-board telematics unit 110 to generate turn-by-turn instructions to a destination. In another embodiment, the map information 254 is not stored in the on-board telematics unit 110 but stored in the control center 124. In this embodiment, the control center 124 generates turn-by-turn instructions and sends the generated instructions to the on-board telematics unit 110 for presentation to the operator. The map information 254 also allows the on-board telematics unit 110 to determine the destination of the vehicle by mapping GPS data (or other localization data) to the address or the name of the destination.

The vehicle status tracker 258 monitors and tracks the status of the vehicle 108. FIG. 3 is a diagram illustrating the process of generating vehicle status information 330 at the on-board telematics unit 110. The sensor interface 210 of the on-board telematics unit 110 is connected to sensors in the vehicle 108. The sensors may include, for example, an engine ignition sensor 312, a seat sensor 316, a speedometer 320 and an odometer 324. The engine ignition sensor 312 detects whether the engine of the vehicle 108 is turned on. The seat sensor 316 detects whether there are passengers (other than a driver) in the vehicle 108. The sensor interface 210 receives raw or pre-processed sensor signals, formats or processes the sensor signals as needed, and then sends digital sensor signal to the vehicle status tracker 262. In response, the vehicle status tracker 262 generates vehicle status information 330 indicating the current state of the vehicle such as whether the engine is turned on/off, the number of passengers in the vehicle, the speed of the vehicle, and the accumulated mileage of the vehicle.

In one embodiment, the vehicle status tracker 248 tracks the vehicle status information 330 starting from a starting reference operation (e.g., the engine is turned on) until an ending reference operation (e.g., the engine is turned off). Based on the tracked vehicle status information 330, the vehicle status tracker 248 generates session information including multiple fields of data indicating the overall state of the vehicle in a driving session. The multiple data fields in the session information may include, for example, the number of passengers, the mileage traveled in this driving session, the average speed of the vehicle, the highest speed of the vehicle, and the number of stops.

Referring back to FIG. 2, the destination repository 258 stores the previous destination information. In one embodiment, the previous destination information includes information about destinations and the session information. For example, the previous destination information includes (i) destinations entered by the operator or automatically detected by the on-board telematics unit, (ii) the session information, (iii) time information (determined by the clock 238), and (iv) information received from the online services (e.g., weather information and road conditions). The previous destination information is stored in the destination repository 258 and then sent to the control center 124 where the information is processed to estimate the operator's characteristics or predict probable actions.

The destinations stored in the destination repository 262 are not limited to the desired information manually entered by the operator. Rather, the telematics automatically determines a set of destinations that a driver can select from even when the operator has not manually entered the destination. By removing the tedious job of manually entering the destination information, the driver can remain more focused on driving task. In one embodiment, the on-board telematics unit 110 determines the operator's destination, for example, by detecting the location of the vehicle 108 using the GPS module 234 when the engine is turned off. By tracking the operator's destinations even without the user's entered information, more data may be made available for processing to obtain more accurate or reliable driving patterns.

The content renderer 266 generates audio and/or video information for presenting to the operator via the speaker (not shown) and the display 240. The audio and/or video information may include, for example, recommendations for the destinations or activities, advertisements customized for the operator based on the prediction or estimation, alerts or alarms indicating road conditions or traffic congestion in routes, and one or more routes to the destinations. The recommendations may be received from the control center 124. In one embodiment, the content renderer 266 is part of a navigation program for generating turn-by-turn instructions. The recommendations may be presented on the display 240 in the form of, for example, advertisements, highlighted icons selectable by the users or points of interest (POI) on a map.

The content renderer 266 may include an online content interface 268. The online content interface 268 receives contents via a network (e.g., Internet). The online content interface 268 interfaces with online content services such as Pandora Radio or YouTube to send requests for contents, receive contents via the network and reproduce the contents. The content render 266 may insert advertisements selected by the control center 124 between units of contents. For example, advertisements may be inserted after each song is finished or a movie clip is finished. The content renderer 266 may also enable the operator to interact with the online content provider. I

In one embodiment, the content renderer 266 obtains and processes additional information associated with the advertisements. The content renderer 266 may retrieve information stored in the memory 250 or communicate with the online services 128 associated with the advertisements directly or via control center 124 to present more helpful information to the operator. For example, when presenting an advertisement for a certain service (e.g., fast-food or coffee shop), the control center interface 270 may obtain locations of nearby fast-food or coffee shop of the advertised brand from the map information 254 or receive the same locations from a server of the fast-food or coffee shop via the communication module 230. The content renderer 266 may also receive and present promotional codes, menu items, contact information or other information associated with the advertised services. In this way, the operator can make decision to visit a recommended business establishment without manually searching for relevant information while driving.

The control center interface 270 performs operations for communicating with the control center 124. The control center interface 270 may perform one or more of the following operations: (i) authenticating login to the control center 124, (ii) generate information for transmission into a format compatible with control center 124, (iii) compress or encrypt information sent to the control center 124, (iv) decompress or decrypt messages received from the control center 124, and (v) collect and maintain statistical data associated with communication to or from the control center 124.

The operator profile 274 includes information about the operator entered by the operator. The operator may store information about the operator such as age, gender, ethnicity, height, weight, home address and phone address. The operator may also store information for accessing online services such as user IDs and passwords. In one embodiment, profiles for two or more users may be stored in the operator profile 274.

### Example Control Center

The control center 124 analyzes information received from the on-board telematics unit 110 and the online services 128 to estimate the operator's characteristics or predict the operator's probable actions. Based on the prediction, the control center 124 generates and sends information for presentation to the operator of the vehicle 108 via the on-board telematics unit 110.

FIG. 4 is a block diagram of the control center 124, according to one embodiment of the present invention. The control center 124 includes, among other components, a telematics communication module 410, a processor 420, an online service interface 430, memory 440 and bus 450 connecting these components. The control center 124 may also include additional components for providing services to the operator of the vehicle 108.

The telematics communications module 410 is hardware, software, firmware or a combination thereof for communicating with the communication module 230 of the on-board telematics unit 110. The telematics communications module 410 may employ various mechanisms for communicating with the on-board telematics unit 110 such as cellular telephony, LTE (Long Term Evolution) Wi-Fi, WiMAX (Worldwide Interoperability for Microwave Access), LMDS (Local Multipoint Distribution Service), UMB (Ultra Mobile Broadband), and GMR (Geo-Mobile Radio Interface).

The processor 420 reads and executes computer instructions stored in the memory 440. More than one processor 420 may be employed to increase the processing capability of the control center 124.

The online service interface 430 is hardware, software, firmware or a combination thereof for interacting with the online services 128. The online service interface 430 may include APIs (application programming interfaces) and network components (e.g., a LAN card) for initializing a session with the online services 128, requesting information from the online services, receiving the requested information and uploading information to the online services 128.

The memory 440 stores computer instructions for retrieval and execution by the processor 420. The computer instructions may include, for example, operator profile module 444, social map analyzer 448, pattern correlator 452, and recommendation module 456. The memory 440 may also include other components for providing various useful services to the operator.

The operator profile module 444 stores profiles of multiple operators that the control center 124 services. A profile for an operator may include, for example, the following information: (i) biometric information (e.g., height and weight), (ii) gender, (iii) operator's user ID in online services, (iv) information about other people related to the operator, (v) operator's explicit preferences (e.g., operator preferences for certain coffee shops), (vi) favorite destinations (e.g., home address or office address), and (vii) phone numbers associated with the operator.

The operators may provide some or all of the profile information via the on-board telematics unit 110 or the web interface (e.g., web browser) connected to the control center 124 via the network 120. In one embodiment, the operator profile module 444 automatically communicates with one or more online services 128 to collect information about the operator. For example, the control center 124 accesses social networking services (e.g., Facebook, Linked-In, Myspace, etc.) where the operator keeps a profile page to obtain information about the operator's profile. The automatic retrieval of information about the operator allows the control center 124 to customize and tailor information for presentation to the operator without requiring the operator to spend a large amount of time to manually input the operator's personal information.

The social map analyzer 448 interfaces with the online services 128, especially social networking services to collect and analyze information associated with users connected to the operator. Based on the access information (e.g., user ID and password) received from the operator or obtained from other sources, the social map analyzer 448 receives social network information about users of the social networking service connected to or having relationships with the operator. Users having such connection or relationships are referred to as “friends” or “followers” in the social networking services.

The social networking information may include, but is not limited to, age, gender, ethnicity, height, weight, home address, office address, favorite brands of products or services, and academic institutions associated with each of the users. The social network information may be analyzed to extract common characteristics of the users connected to the operator. The operator is assumed to share the common characteristics with the connected users. Based on such assumption, the control center 124 may generate and send information that is more relevant and useful to the operator.

The common characteristics may indicate, for example, socioeconomic status of the users, geographic concentration of the users, age range, and preferred brand of services or products (e.g., Starbucks coffee shop), hobbies, work places, attending or graduated schools, musical taste, restaurant preference, movies, clothing brands, and news or contents of interest. In one embodiment, the control center 124 categorizes the operators into categories based on the common characteristics. Each category of operators is likely to share the same or similar brand of services or products and share similar interests. For example, a category of operators may prefer luxury brands of products whereas another category of operators may prefer less expensive brands of coffee. Similarly, categories may relate to marital status or family status of the users. Different categories of operators are likely to show interests in different types of services, products, events or activities. For example, a graduate from a certain college may prefer to attend sports events or charity events hosted by the college. In one embodiment, the control center 124 classifies the operators into one or more categories, and provides information customized for the operators based on the classification.

The pattern correlator 452 analyzes the previous destination information received from the on-board telematics unit 110 to extract the operator's driving patterns. The destination information stored in the destination repository 262 of the on-board telematics unit 110 may be received from the operator or determined automatically at the on-board telematics unit 110 without any user input. The pattern correlator 452 may apply statistical analysis or data mining algorithm on data fields of the destination information to extract driving patterns of the operator's driving sessions. The statistical analysis or data mining algorithms may perform, for example, regression analysis, clustering, genetic algorithms or support vector machines analysis to extract driving patterns. The extracted driving patterns may indicate, for example, the operator's favorite destinations on weekdays or weekends, changes in driving destinations based on presence of any passengers, typical driving distances, average driving speed for different destinations, probable destinations from certain starting locations, and the number of intermediate destinations based on the final set of destinations. Also, location of vehicle prior to the set destination and time of that the ignition was turned on can be analyzed to predict probable destinations from a particular location or time.

The recommendation module 456 receives the common characteristics from the social map analyzer 448 and/or the extracted driving patterns from the pattern correlator 452 and generates information for presentation to the operator. The information generated by the recommendation module 456 may be in various formats including, among others, a file, a page of data (e.g., webpage), audio file, and a string of alphanumeric characters. To generate information more relevant and useful to the operator, the recommendation module 456 may also receive and take into account current session information. The current session information may include, for example, the destination as entered by the operator, the current state of the vehicle (e.g., engine ignition turned on), the starting location of the vehicle (e.g., the location where the engine was turned on) and current time (e.g., time of day or week). The generated information is then sent to the on-board telematics unit 110 for presentation to the operator.

In one embodiment, the recommendation module 456 incorporates advertisements in the information for presentation to the operator. The advertisements for presentation to the operator are selected based on the operator's driving patterns, characteristics, the distance from the current location to the business premises of an advertisement sponsor, the duration of driving session, current time and probable actions. For example, if an operator often visits certain types of business (e.g., coffee shop) when the starting from a certain location or at certain time of the day (e.g., around 3:00 PM on weekdays), the recommendation module 456 may select advertisements related to the same types of business when the time or starting location coincides with the driving pattern. Also, the recommendation module 456 may instruct the content renderer 266 to present advertisements for a business or service establishment when the vehicle enters a certain range (e.g., one mile) from the establishment. In this way, the advertisements presented to the operator are likely to be useful and relevant to the operator.

In one embodiment, the recommendation module 456 receives information from the online services 128 to check weather conditions, road conditions or major events at the likely destination or on routes to the likely destination even if the operator does not expressly indicate the destination. For example, if the driving pattern indicates that the operator drives from city X to city Y every Saturday morning, the recommendation module 456 may automatically check the road conditions or traffic congestion along the route to city Y, and recommend an alternative route if there is a better route to city Y.

The recommendation module 456 may also take into account the arrival time at the destination, and present activities to the operator. For example, the recommendation module 456 estimates the time at which the operator is likely to reach the probable destination (e.g., city Y), and recommend taking an umbrella if rain is expected at the arrival time or drop by at a college reunion event planned to be held at city Y around the arrival time. Note that such recommendations may be produced without any explicit requests from the operator.

In one embodiment, the recommendation module 456 determines a list of probable destinations and estimated time to drive to the destinations. The determination may be performed automatically without receiving any explicit input from the operator. For example, the recommendation module 456 may determine that the operator prefers a certain brand of coffee shops. The recommendation module 456 may send recommendation including the locations for the certain brand of coffee shops to the on-board telematics unit 110. The on-board telematic unit 110 may present a list of preferred destinations (e.g., brand X coffee shops), and estimated time to drive to each of the preferred destinations. For example, the on-board telematics unit 110 may present five closest coffee shops of a certain brand in the vicinity of the vehicle 108.

In one embodiment, the common characteristics generated at the social map analyzer 448 and/or the extracted driving patterns generated at the pattern correlator 452 are used for various analysis and/or actions other than generating materials for presentation to the operator. Such analysis and/or actions may include, for example, providing statistical information for designing products or services.

### Intelligent Selection of Advertisements

The recommendation module 456 may present advertisements or other contents that are relevant to the operator of the vehicle based on available information. The available information may include, but is not limited to, the current location of the vehicle, information about the operator, the time information, and the destination of the vehicle. Such presentation of advertisements or other contents may be performed autonomously or with the approval of the operator.

In one embodiment, the recommendation module 456 selects advertisements or contents for presentation to the operator based on the current destination set by the operator. For example, if a user sets an amusement park as the destination, the recommendation module 456 may recommend advertisement or contents (e.g., infomercial advertisement) related to the amusement park. The recommendation module 456 may also select advertisements for business near the current destination. For example, if a customer sets a restaurant as a destination, the recommendation module 456 may select and present advertisements of movie theaters, book stores, or coffee shop near the set destination.

In one embodiment, the recommendation module 456 selects advertisements or contents for presentation to the operator based on the operator's driving pattern. Based on the previous destination that the operator entered in the on-board telematics unit 110, the recommendation module 456 predicts the next likely destination. Statistical analysis or pattern recognition algorithm may be adopted to predict the next destination. For example, if the operator generally heads to a gym before going to a grocery shop, the recommendation module 456 may select advertisements of other grocery shops near the gym when the engine of the vehicle is turned on at the gym.

In one embodiment, the recommendation module 456 selects advertisements or contents for presentation to the operator based on the time information. If the engine of the vehicle is turned on at a certain time and location, the recommendation module 456 can select advertisements for locations likely to be the operator's next destination or interest. For example, if the engine of the vehicle is turned on around noon, the recommendation module 456 may select advertisements of nearby restaurants for presentation to the operator. The recommendation module 456 may also filter the advertisements based on, for example, the time needed to drive to locations associated with the advertisements, and business hours of the business establishments associated with the advertisements.

In one embodiment, the recommendation module 456 selects advertisements or contents for presentation to the operator based on the length of time that the operator has been driving. If a driver has been driving over a predetermined amount of time, the recommendation module 456 may select advertisements associated with a coffee shop. If the time is late in the evening, the recommendation module 456 may select advertisements for a nearby lodging facility.

Although the selection of advertisements is described above as being performed at the recommendation module 456, some or all of the selection process may be performed at the on-board telematics unit 110.

### Overall Process for Generating Customized Information for Operator

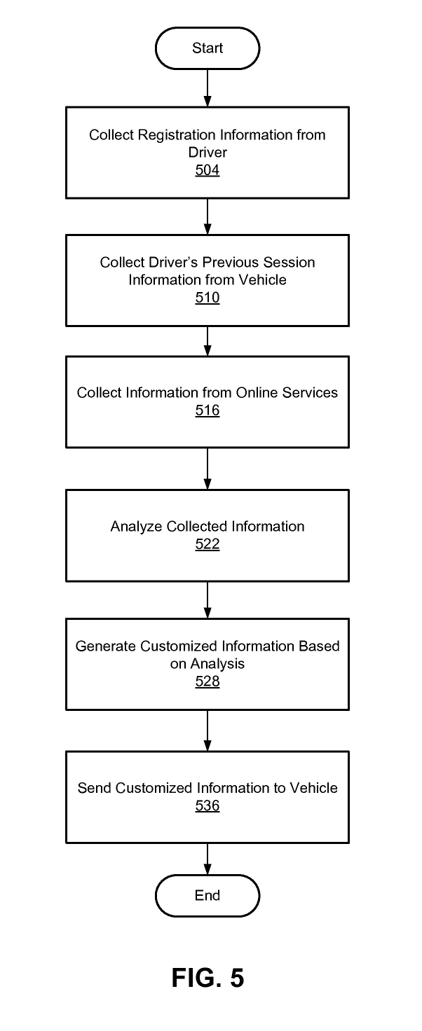

FIG. 5 is a flowchart illustrating a method of generating information customized for an operator, according to one embodiment of the present invention. The information about the operator is collected 504 at the on-board telematics unit 110 or at the control center 124. The information collected may include, but is not limited to, age, gender, ethnicity, height, weight, home address, phone address of the user of the operator and the operator's user ID for online services (e.g., social networking services). The information may be stored in the operator profile 274 of the on-board telematics unit 110 and be sent over to the control center 124.

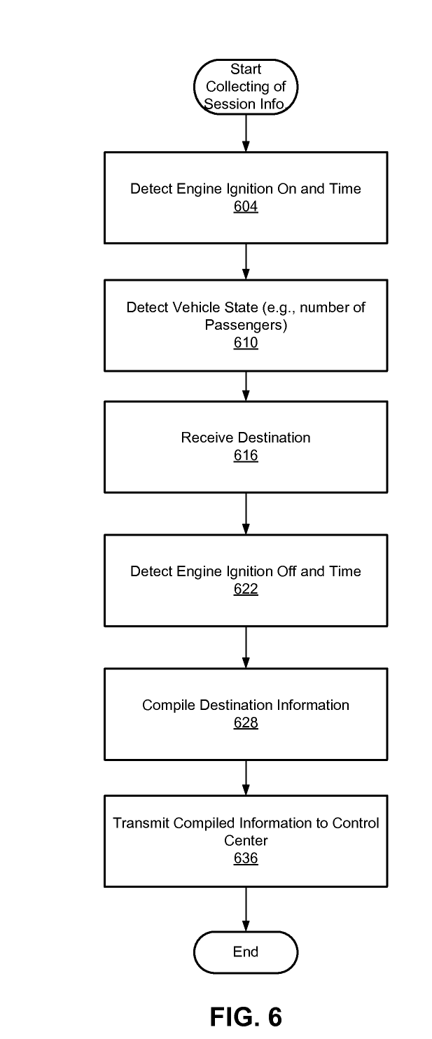

At the on-board telematics unit 510, the previous session information associated with the previous driving session is collected 510, as described below in more detail with reference to FIG. 6. The previous session information may include, but is not limited to the destinations, vehicle states, times of driving, and driving distances. The on-board telematics unit 510 may send the previous session information to the control center 124 soon after the destination information is generated for a current driving session. Alternatively, the on-board telematics unit 510 may aggregate the previous destination information for multiple previous driving sessions and send it to the on-board telematics unit 510 at certain intervals (e.g., every week or every month).

The control center 124 also collects 516 information associated with the operator from the online services 128. To collect the information, the control center 124 may use the operator's access information (e.g., user ID) previously received. The information collected from the online services 128 may include, but is not limited to, information about users connected to the operator in a social networking service, and profiles of such connected users.

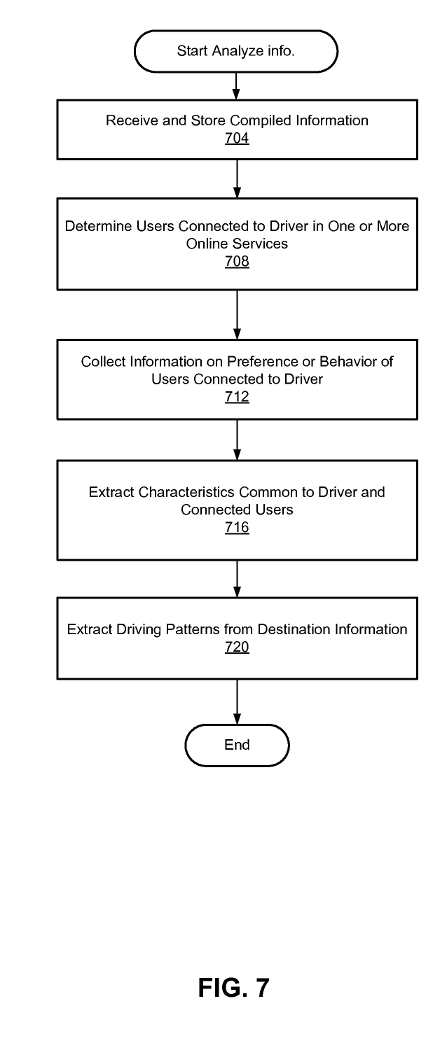

The control center 124 then analyzes 522 the previous destination information and the information collected from the online services 128 to extract the operator's driving patterns or operator's characteristics, as described below in detail with reference to FIG. 7. Various statistical analysis and data mining tools may be adopted to extract the driving patterns and/or the operator's characteristics.

The control center 124 generates 528 information customized for the operator based on the driving patterns and the operator's characteristics. The customized information may include recommendation for a destination, recommendation for an activity or advertisements. For example, if the operator likes a certain brand of coffee shops, the control center 124 may identify the same brand of coffee shops in the vicinity of a route from an origin and a destination.

The control center 124 sends 536 the customized information to the vehicle 108 via the communication infrastructure 130. For example, the control center 124 sends a sound file including advertisement or recommendation asking if the operator would like to stop by at a coffee shop that the operator may like en-route to the destination.

The steps and sequences of the steps illustrated in FIG. 5 are merely illustrative. Some steps in FIG. 5 may be omitted. For example, the control center 124 may collect and analyze information from the on-board telematics unit 510 but not from the online services 128. In such an example, step 516 may be omitted. The sequence of steps may also be modified. For example, collecting 510 the session information may be performed after or performed in parallel with collecting 516 information from the online services 128.

### Process for Tracking Operator's Activity

FIG. 6 is a flowchart illustrating collecting of session information, according to one embodiment of the present invention. In one embodiment, the on-board telematics unit 110 detects 604 the engine ignition and the time at which the engine was turned on to start a driving session of the vehicle 108. In one embodiment, the on-board telematics unit 110 detects and logs the time at which the engine was turned on.

The on-board telematics unit 110 then detects 610 the states of the vehicle 108 using sensors connected to the on-board telematics unit 110. The state of the vehicle 108 includes, for example, the current location of the vehicle 108, the number of passengers and the identity of the operator. In one embodiment, each operator may be identified by sensing a vehicle key that is uniquely assigned to the operator.

In one embodiment, the on-board telematics unit 110 receives 616 destination associated with the current driving session. Alternatively, the on-board telematics unit 110 may determine the destination based on the location of the vehicle 108 at the time the engine ignition is turned off. For this purpose, the on-board telematics unit 110 may detect 622 whether the engine is turned off and the time that the engine was turned off. After the engine is turned off, the on-board telematics unit 110 compiles 628 the previous destination information for the driving session that just ended. The compiled destination information is then sent 636 to the control center 124 for analysis and further actions.

The steps and sequences of steps in FIG. 6 are merely illustrative. Some steps of FIG. 6 may be omitted. For example, the step of detecting 622 the engine being turned off may be omitted. In such an example, the destination may rely on the information provided by the operator.

### Process for Analyzing Collected Information

FIG. 7 is a flowchart illustrating a process of analyzing the collected information, according to one embodiment of the present invention. The control center 124 receives and stores 704 the previous destination information compiled at the on-board telematics unit 110.

In one embodiment, using the operator's ID for online services (e.g., social networking services), the control center 124 accesses the social networking services to determine 708 other users of the social networking services connected to the operator.

The control center 124 also collects 712 information about the users connected to the operators in the online services. The information about the connected users may be obtained, for example, from the profile pages of the users that are publicly accessible.

The control center 124 then extracts 716 characteristics likely to be common to the operator and the connected users by performing statistical analysis and data mining on the information about the operator and information about other users connected to the operator.

The control center 124 also extracts 720 the operator's driving patterns by performing statistical analysis and data mining on the destination information received from the on-board telematics unit 110.

Although the example of FIG. 7 is described above primarily with reference to the online services 128 such as social networking services that establish relationships or connections between the users, information provided by other types of online services may also be the subject of analysis. For example, the online services may include weather forecast services that provide weather information about the starting location or destination of the driving session. Current weather state, collected from such online services, may be used for additional information for analysis.

### Alternative Embodiments

In one embodiment, events associated with the operator are monitored via the online services 128. The control center 124 analyzes messages (e.g., instant messages or emails) to or from the operator via an online service 128. The control center 124 may extract the location and time of the event based on the messages. When the operator turns on the engine at a time or location proximate to the event, the operator may remind the user or recommend the location to the operator via the onboard telematics unit 110.

In one embodiment, the on-board telematics unit 110 is capable of accessing the online services 128 without the intervention of the control center 124. The on-board telematics unit 110 may embody some of the functionalities of the control center 124, such as collecting information from the online services 128 and performing analysis on the collected data without assistance from the control center 124.

Although the present invention has been described above with respect to several embodiments, various modifications can be made within the scope of the present invention. Accordingly, the disclosure of the present invention is intended to be illustrative, but not limiting, of the scope of the invention, which is set forth in the following claims.

What is claimed is:

1. A method of presenting information to an operator of a vehicle, comprising:
receiving previous destination information of the vehicle for a plurality of previous driving sessions;
extracting a driving pattern of the operator by analyzing the previous destination information;
generating information for presentation to the operator by predicting an activity or estimating characteristics of the operator in a current driving session based on the extracted driving pattern; and
sending the generated information to the vehicle for presentation to the operator.

2. The method of claim 1, further comprising receiving current session information associated with the current driving session, the information for presentation generated based further on the current session information.

3. The method of claim 2, wherein the current session information comprises at least one of (i) a destination as entered by the operator, (ii) a current location of the vehicle, (iii) a current state of the vehicle, and (iv) a current time.

4. The method of claim 1, further comprising:
receiving access information of the operator for identifying users connected to the operator in an online service;
collecting information about the users connected to the operator in the online service;
extracting common characteristics of the users connected to the operator; and
generating information for presentation based further on the extracted common characteristics.

5. The method of claim 4, wherein the information about the users comprise at least one of age, gender, ethnicity, height, weight, home address, office address, favorite brands of product or services, and academic institutions associated with each of the users.

6. The method of claim 4, wherein the online service comprises a social networking service.

7. The method of claim 1, wherein the previous destination information comprises previous destinations indicated by the operator.

8. The method of claim 1, wherein the previous destination information comprises locations of the vehicle when an engine of the vehicle is turned off.

9. The method of claim 1, wherein the previous destination information comprises one or more of (i) destinations manually entered by the operator or automatically detected by the vehicle, (ii) status of the vehicle detected by one or more sensors in the vehicle, and (iii) time information.

10. The method of claim 9, wherein the previous destination information comprises information received from an online service.

11. The method of claim 9, wherein the one or more sensors comprise at least one of (i) a sensor detecting engine ignition status of the vehicle, (ii) a seat sensor, (iii) a speedometer and (iv) an odometer.

12. The method of claim 1, wherein extracting the driving pattern comprises performing a statistical analysis or data mining on the previous destination information.

13. The method of claim 1, wherein the generated information comprises at least one of a recommended destination, a recommended activity and an advertisement.

14. The method of claim 1, wherein the generated information comprises a plurality of recommended destinations matching a preference of the operator.

15. The method of claim 14, further comprising receiving locations and times for driving to the recommended destinations, the locations and the times for driving to the recommended destinations included in the information for presentation to the operator.

16. The method of claim 1, wherein the generated information is for including in an advertisement on an Internet radio or for displaying on a display device in the vehicle.

17. A computing device for generating information customized for an operator of a vehicle, comprising:
a telematics communication module configured to receive previous destination information of the vehicle for a plurality of previous driving sessions;
a pattern correlator configured to extract a driving pattern of the operator by analyzing the previous destination information; and
a recommendation module configured to generate information for presentation to the operator by predicting activity or estimating characteristics of the operator in a current driving session based on the driving pattern, the generated information sent to the vehicle for presentation to the operator.

18. The computing device of claim 17, wherein the telematics communication module is further configured to receive current session information associated with the current driving session, and the recommendation module is configured to generate the information for presentation based further on the current session information.

19. The computing device of claim 17, wherein the current session information comprises at least one of (i) a destination as entered by the operator, (ii) a current location of the vehicle, (iii) a current state of the vehicle, and (iv) a current time.

20. The computing device of claim 17, further comprising an analyzer configured to:
collect information about users connected to the operator in an online service based on access information of the operator received from the operator; and
extract common characteristics of the users connected to the operator, the information for presentation generated based further on the extracted common characteristics.

21. The computing device of claim 20, wherein the online service comprises a social networking service.

22. The computing device of claim 17, wherein the previous destination information comprises previous destinations indicated by the operator and locations of the vehicle when an engine of vehicle is turned off.

23. The computing device of claim 17, wherein the previous destination information comprises one or more of (i) destinations manually entered by the operator or automatically detected by the vehicle, (ii) status of the vehicle detected by one or more sensors in the vehicle, and (iii) time information.

24. The computing device of claim 17, wherein the one or more sensors comprise at least one of (i) a sensor detecting engine ignition status of the vehicle, (ii) a seat sensor, (iii) a speedometer and (iv) an odometer.

25. The computing device of claim 17, wherein the generated information comprises at least one of a recommended destination, a recommended activity and an advertisement.

26. The computing device of claim 17, wherein the generated information comprises a plurality of recommended destinations matching a preference of the operator.

27. The computing device of claim 26, further comprising receiving locations and times for driving to the recommended destinations, the locations and the times for driving to the recommended destinations included in the information for presentation to the operator.

28. A method of presenting information to an operator of a vehicle in a telematics unit, comprising:
storing previous destination information of the vehicle for one or more previous driving sessions;
sending the previous destination information to a remote computing device to extract a driving pattern of the operator by analyzing the previous destination information, the remote computing device generating information for presentation to the operator by predicting activity or estimating characteristics of the operator in a current driving session based on the driving pattern;
receiving the generated information from the control center; and
presenting the generated information to the operator.

29. The method of claim 28, further comprising:
generating current session information associated with the current driving session; and
sending the current session information to the remote computing device, the remote computing device generating the information for presentation based further on the current session information.

30. The method of claim 28, wherein the remote computing device generates the information for presentation based further on information collected about the users connected to the operator in a online service.

31. The method of claim 28, further comprising storing destination received from the operator in the previous destination information.

32. A telematics units in a vehicle, comprising:
a destination repository configured to store previous destination information of the vehicle for one or more previous driving sessions;
a communication module configured to:
send the previous destination information to a remote computing device to extract a driving pattern of the operator by analyzing the previous destination information, the remote computing device generating information for presentation to the operator by predicting activity or estimating characteristics of the operator in a current driving session based on the driving pattern; and
receive the generated information from the control center; and
a display module configured to present the generated information to the operator.
